(19) United States
(12) Patent Application Publication
(10) Pub. No.: US 2014/0018131 A1
(43) Pub. Date: Jan. 16, 2014

(54) MOBILE TERMINAL AND NETWORK LOCKING METHOD THEREFOR

(71) Applicants: Xiaofeng Yao, Shenzhen City (CN); Hua Lin, Shenzen City (CN)

(72) Inventors: Xiaofeng Yao, Shenzhen City (CN); Hua Lin, Shenzen City (CN)

(73) Assignee: ZTE CORPORATION, Shenzhen, Guangdong Province (CN)

(21) Appl. No.: 13/985,577

(22) PCT Filed: Jun. 21, 2011
(86) PCT No.: PCT/CN2011/076012

§ 371 Date: Aug. 15, 2013

(30) Foreign Application Priority Data
Mar. 30, 2011 (CN) 201110079065.6

(51) Int. Cl. H04W 12/08

(52) U.S. Cl. CPC H04W 12/08
USPC 455/558

(57) ABSTRACT

Disclosed in the present document is a network locking method for a mobile terminal. An encryption chip is built in the mobile terminal, and customization information is saved in a Subscriber Identity Module (SIM) card, an encryption chip and a mobile terminal main chip respectively. After the mobile terminal is powered on, the encryption chip compares its customization information with those in the mobile terminal main chip and the SIM card respectively, and prevents communication between the mobile terminal main chip and the SIM card if any comparison shows that the information is inconsistent; Meanwhile, a mobile terminal is also disclosed in the present document.

### TECHNICAL FIELD

The present document relates to mobile communication technology, and more particularly, to a mobile terminal and a network locking method thereof.

### BACKGROUND OF THE RELATED ART

As the currently most commonly used mobile terminals, the development and popularization of mobile phones more and more affects the information communication ways, and the phones have become an integral part of people's daily life and work. Currently, most mobile phone manufacturers cooperate with the operators and use the customized way to obtain profits, however, the operator, in order to protect his legitimate rights and interests, generally requires to lock the networks for the customized mobile phone, that is, lock certain specific networks, so that the user can only use the operator's services to protect his own benefits. With the development of internationalized economy, services provided by many large operators can cover multiple networks. If a operator needs to customize a batch of mobile phones that is sold out to different network coverage regions, the mobile phone manufacturer, before delivering the mobile phones, must perform different network locking for mobile phones delivered to different areas, which has very low efficiency, moreover, the network-locked mobile phones can only be used in specific networks, and if the operator needs to internally schedule across the networks, the mobile phones must be returned to the manufacturer to re-lock their networks, whose cost is too high.

### SUMMARY OF THE INVENTION

In view of this, the main purpose of the present document is to provide a mobile terminal and a network locking method thereof to achieve flexible network locking of said mobile terminal.

To achieve the above-mentioned purpose, the technical solution of the present document is achieved as that:

the present document provides a network locking method for a mobile terminal, and said mobile terminal has a built-in encryption chip, and customization information is stored in a Subscriber Identity Module (SIM) card, an encryption chip and a mobile terminal main chip respectively;

after said mobile terminal is powered on, said encryption chip compares customization information stored therein with those in said mobile terminal main chip and said SIM card respectively, and after any comparison indicates that the information is inconsistent, communication between said mobile terminal main chip and said SIM card is prevented.

In the above-mentioned solution, said customization information is operator information, or operator information and partner information.

In the above-mentioned solution, said storing the customization information in the SIM card is as follows: when said customization information is the operator information, writing the operator information into a group identification document 1 (GID1) of said SIM card;

when said customization information is the operator information and partner information, writing the operator information into the GID1 file of said SIM card, and writing the partner information into a GID2 file of said SIM card.

In the above-mentioned solution, said encryption chip comparing the customization information with that in said mobile terminal main chip is:

said encryption chip sending a information acquisition signal to said mobile terminal main chip and requesting to acquire the customization information;

after said mobile terminal main chip receives the information acquisition signal, it sending the customization information in its own software security zone to said encryption chip;

said encryption chip comparing the customization information stored therein with the customization information from said mobile terminal main chip, and when the information is inconsistent, preventing the communication between said mobile terminal main chip and said SIM card.

In the above-mentioned solution, said method further comprises: said encryption chip comparing the customization information stored therein with the customization information from said mobile terminal main chip, and when the information is consistent, sending a software verification success signal to said mobile terminal main chip;

after said mobile terminal main chip receives the software verification success signal, sending a information acquisition signal to the encryption chip, and requesting to acquire the customization information in said encryption chip;

after said encryption chip receives the information acquisition signal from the mobile terminal main chip, sending the stored customization information to the mobile terminal main chip;

said mobile terminal main chip comparing the customization information in its own software security zone with the customization information from said encryption chip, and when the information is consistent, said mobile terminal main chip notifying said encryption chip that a hardware verification is successful, and after said encryption chip receives the notification of hardware verification success, executing the step of said encryption chip comparing its customization information with the customization information in said SIM card; when the information is inconsistent, notifying said encryption chip that said hardware verification is failed, and after said encryption chip receives said notification of hardware verification failure, preventing the communication between said mobile terminal main chip and said SIM card.

In the above-mentioned solution, said encryption chip comparing its customization information with the customization information in said SIM card is:

when there is a SIM card inserted in said mobile terminal, said encryption chip sending an information acquisition signal to said SIM card, and requesting to acquire the customization information in said SIM card;

after said SIM card receives said information acquisition signal, it sending the customization information stored therein to said encryption chip;

said encryption chip comparing the customization information stored therein with the customization information from said SIM card, and if the information is inconsistent, preventing the communication between said mobile terminal main chip and said SIM card.

In the above-mentioned scheme, said preventing the communication between said mobile terminal main chip and said SIM card is: said encryption chip of the mobile terminal intercepting the communication information between the mobile terminal main chip and the SIM card, and interrupting the normal communication between the mobile terminal main chip and the SIM card.

The present document provides a mobile terminal, and said mobile terminal comprises: an encryption chip, a mobile terminal main chip, and a SIM card module; wherein

said encryption chip, in which the customization information is stored, is used to, after said mobile terminal is powered on, compare its customization information with those of the mobile terminal main chip and the SIM card module respectively, and if any comparison indicates that the information is inconsistent, prevent communication between said mobile terminal main chip and said SIM card module;

said mobile terminal main chip, in which the customization information is stored, is used to provide its own customization information to said encryption chip for comparison;

said SIM card module, is used to read the customization information in said SIM card, and provide said customization information to said encryption chip.

In the above-mentioned solution, said encryption chip is specifically used to, after any comparison indicates that the information is inconsistent, intercept the communication information between said mobile terminal main chip and said SIM card module, and interrupt the normal communication between said mobile terminal main chip and said SIM card module.

The present document provides a mobile terminal and a network locking method thereof, said mobile terminal has a built-in encryption chip, and customization information is stored in the SIM card, the encryption chip and the mobile terminal main chip respectively; after said mobile terminal is powered on, said encryption chip compares its customization information with those in said mobile terminal main chip and said SIM card respectively, and after any comparison indicates that the information is inconsistent, the communication between said mobile terminal main chip sand said SIM card is prevented. The present document achieves flexible network locking of said mobile terminal, and in the case that the customization information is the operator information or the operator information and the partner information, in any network where the same operator or the same operator and partner can provide services, the mobile terminal can work normally after simply inserting an operator customized SIM card, thus avoiding the problem that said mobile terminal must be returned to the manufacturer to get network re-locked when it is scheduled across networks inside the operator, thus improving efficiency and reducing the cost. Meanwhile, the solution of the present document uses the method of combining software and hardware to compare the information with each other, hence effectively preventing various illegal cracks to the mobile terminal software.

### BRIEF DESCRIPTION OF DRAWINGS

FIG. 1 is a flow chart of a network locking method for a mobile terminal in accordance with the present document;

FIG. 2 is a structural diagram of a mobile terminal implemented in accordance with the present document.

### PREFERRED EMBODIMENTS OF THE INVENTION

The basic idea of the present document is: the mobile terminal has a built-in encryption chip, and there is customization information stored in the SIM card, the encryption chip and the mobile terminal main chip respectively; after the mobile terminal is powered on, the encryption chip compares its customization information with those in the mobile terminal main chip and the SIM card respectively, and if any comparison indicates that the information is inconsistent, the communication between the mobile terminal main chip and the SIM card is prevented.

The present document will be illustrated in further detail below in combination with the accompanying drawings and specific embodiments.

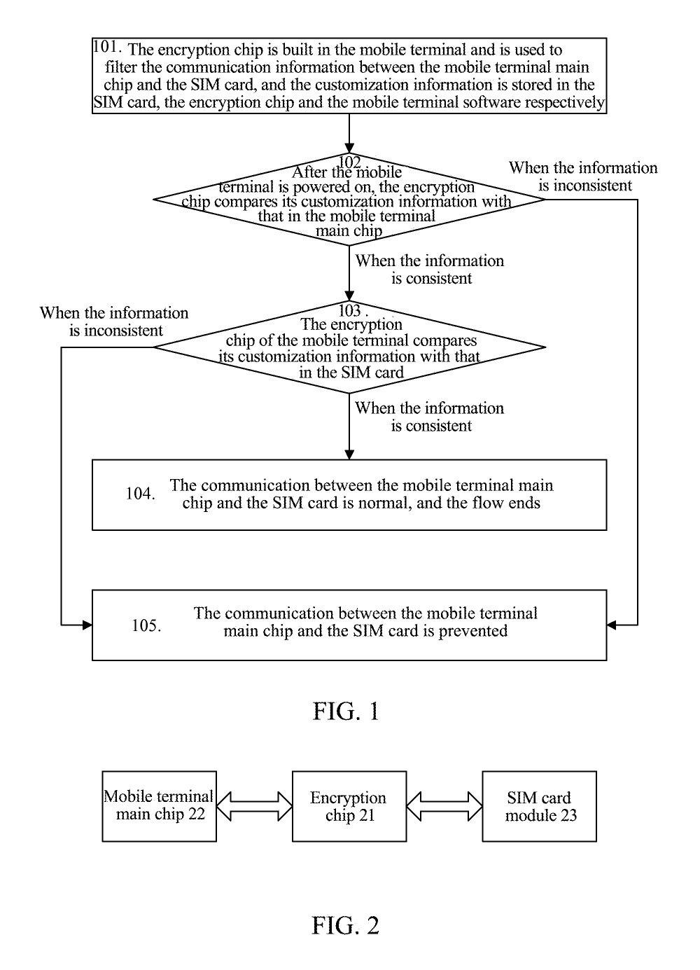

The present document provides a method for locking the operator of the mobile terminal, and as shown in FIG. 1, the method comprises the following steps:

In step 101, the encryption chip is built in the mobile terminal and is used to filter the communication information between the mobile terminal main chip and the SIM card, and the customization information is stored in the SIM card, the encryption chip and the mobile terminal software respectively;

specifically, an encryption chip is added in the mobile terminal, which is serially connected between the mobile terminal main chip and the SIM card, and the encryption chip is used to filter the communication information between the mobile terminal main chip and the SIM card, and the customization information is written into the software security zones of the SIM card, the encryption chip and the mobile terminal main chip respectively in advance;

the customization information might be the operator information or the operator information and the partner information; the operator information generally comprises: operator name, operator code, and so on; the partner information is the information of the manufacture that signs a partnership with the operator, generally comprising: partner name, partner code, and so on;

writing the customization information into the SIM card may be: when the customization information is the operator information, writing the operator information into the GID1 file of the SIM card; when the customization information is the operator information and the partner information, writing the operator information into the GID1 file of the SIM card, and writing the partner information into the GID2 file of the SIM card;

that the encryption chip filters the communication information between the mobile terminal main chip and the SIM card generally comprises: after booting each time, the encryption chip runs automatically, and only acquires the preset information between the mobile terminal main chip and the SIM card, while transparently transmits the remaining information, herein, the preset information is generally an interaction signal related to the customization message; information in the encryption chip can only be written, modified, and erased by the mobile terminal manufacturer.

In Step 102, after the mobile terminal is powered on, the encryption chip compares its customization information with that in the mobile terminal main chip, and when the information is consistent, it is to proceed to step 103; otherwise, it is to proceed to step 105;

specifically, after each reboot of the mobile terminal, the encryption chip sends a information acquisition signal to the mobile terminal main chip, and requests to acquire the customization information; after the mobile terminal main chip receives the information acquisition signal, it sends the customization information in the software security zone to the encryption chip; the encryption chip compares the customization information sent by the mobile terminal main chip with its own stored customization information, and when the information is consistent, it sends a software verification success signal S to the mobile terminal main chip, which indicates that the software verification by the hardware is successful, and it is to proceed to step 103; otherwise, it is to proceed to step 105;

when the customization information is the operator information and the partner information, the encryption chip compares the customization information sent by the mobile terminal main chip with its own stored customization information, specifically: firstly, the encryption chip compares the operator information sent by the mobile terminal main chip with its stored operator information, and if the information is consistent, then it compares the partner information sent by the mobile terminal main chip with its own stored partner information;

Furthermore, after the mobile terminal main chip receives the software verification success signal S, the present step further comprises: the mobile terminal main chip sends a information acquisition signal to the encryption chip and requests to acquire the customization information in the encryption chip; after the encryption chip receives the information acquisition signal from the mobile terminal main chip, it sends its stored customization information to the mobile terminal main chip; the mobile terminal main chip compares the customization information sent by the encryption chip with the customization information in its own software security zone, and when the information is consistent, it notifies the encryption chip that the hardware verification is successful, which indicates that the hardware verification by the software is successful, and after the encryption chip receives the notification of the hardware verification success, it is to proceed to step 103; when the information is inconsistent, it notifies the encryption chip that the hardware verification fails, and after the encryption chip receives the notification of the hardware verification failure, it is to proceed to step 105;

furthermore, in this step, if the mobile terminal software in the mobile terminal main chip is cracked or erased, and if the encryption chip does not receive the customization information returned by the mobile terminal main chip within the specified time period, it is to proceed to step 105.

Through the approach in this step, the hardware and software are combined to compare the customization information with each other, thus effectively preventing all kinds of illegal cracks to the mobile terminal software.

Step 103: The encryption chip of the mobile terminal compares its customization information with that in the SIM card, and when the information is consistent, it is to proceed to step 104; otherwise, it is to proceed to step 105;

specifically, when a SIM card is inserted in the mobile terminal, the encryption chip automatically sends a information acquisition signal to the SIM card and requests to acquire the customization information in the SIM card; after the SIM card receives the information acquisition signal, it sends its own stored customization information to the encryption chip; the encryption chip compares the customization information sent by the SIM card with its own stored customization information, and when the information is consistent, it sends a comparison success signal to the SIM card, and it is to proceed to step 104; otherwise, it is to proceed to step 105;

when the customization information is the operator information and the partner information, the encryption chip compares the customization information sent by the SIM card with its own stored customization information, specifically: firstly, the encryption chip compares the operator information sent by the SIM card with its own stored operator information, and if the information is consistent, compares the partner information sent by the SIM card with its own stored partner information.

Step 104: The communication between the mobile terminal main chip and the SIM card is normal, and the flow ends;

herein, the encryption chip transparently transmits the communication information between the mobile terminal main chip and the SIM card.

Step 105: the communication between the mobile terminal main chip and the SIM card is prevented;

Specifically, the encryption chip serially connected between the mobile terminal main chip and the SIM card intercepts the communication information between the mobile terminal main chip and the SIM card, and interrupts the normal communication between the mobile terminal main chip and the SIM card.

To achieve the above-mentioned method, the present document also provides a mobile terminal, and as shown in FIG. 2, the mobile terminal comprises: an encryption chip 21, a mobile terminal main chip 22, and a SIM card module 23; wherein,

the encryption chip 21, in which the customization information is stored, is used to, after the mobile terminal is powered on, filter the communication information between the mobile terminal main chip 22 and the SIM card module 23; compare the customization information with those in the mobile terminal main chip 22 and the SIM card module 23 respectively, and if any comparison indicates that the information is inconsistent, prevent the communication between the mobile terminal main chip 22 and the SIM card module 23;

the mobile terminal main chip 22, in which the customization information is stored, is used to provide its own customization information to the encryption chip 21 for comparison;

the SIM card module 23, is used to read the customization information in the SIM card, and provide the customization information to the encryption chip 21;

the customization information might be the operator information or the operator information and the partner information;

furthermore, when the customization information is the operator information, the customization information in the SIM card is: writing the operator information into the GID1 of the SIM card; when the customization information is the operator information and the partner information, the customization information in the SIM card is: writing the operator information into the GID1 file of the SIM card, and writing the partner information into the GID2 file of the SIM card.

The encryption chip 21 is specifically used to, after booting each time, send the information acquisition signal to the mobile terminal main chip 22 and request to acquire the customization information, and compare the customization information from the mobile terminal main chip 22 with its own stored customization information after receiving the customization information from the mobile terminal main chip, and when the information is inconsistent, prevent the communication between the mobile terminal main chip 22 and the SIM card module 23; and when the information is consistent, send the software verification success signal S to the mobile terminal main chip 22, and when there is SIM card inserted, automatically send the information acquisition signal to the SIM card module 23 and request to acquire the customization information of the SIM card; and after receiving the customization information sent by the SIM card module 23, compare the customization information from the SIM card module 23 with its own stored customization information, and when the information is inconsistent, prevent the communication between the mobile terminal main chip 22 and the SIM card module 23; when the information is consistent, send a comparison success signal to the SIM card module 23, and transparently transmit the communication information between the mobile terminal main chip 22 and the SIM card module 23, so that the mobile terminal can communicate normally;

furthermore, that the encryption chip 21 prevents the communication between the mobile terminal main chip 22 and the SIM card module 23 particularly is: the encryption chip 21 intercepts the communication information between the mobile terminal main chip 22 and the SIM card module 23, and interrupts the normal communication between the mobile terminal main chip 22 and the SIM card module 23;

the mobile terminal main chip 22 is specifically used to, after receiving the information acquisition signal sent by the encryption chip 21, send the customization information in its own software security zone to the encryption chip 21, and receive the software verification success signal S from the encryption chip 21;

the SIM card module 23 is specifically used to, after receiving the information acquisition signal sent by the encryption chip 21, read the customization information stored in the SIM card and send it to the encryption chip 21, and receive the comparison success signal from the encryption chip 21;

the mobile terminal main chip 22 is further used to, after receiving the software verification success signal S, send the information acquisition signal to the encryption chip 21, and request to acquire the customization information in the encryption chip 21; after receiving the customization information sent by the encryption chip 21, compare the customization information from the encryption chip 21 with the customization information in the security zone of its own mobile terminal software, and when the information is consistent, notify the encryption chip 21 that the hardware verification is successful; and when the information is inconsistent, notify the encryption chip 21 that the hardware verification fails;

the encryption chip 21 is further used to, after receiving the information acquisition signal from the mobile terminal main chip 22, send the stored customization information to the mobile terminal main chip 22, and after receiving the notification of hardware verification success sent by the mobile terminal main chip 22, compare the customization information with that in the SIM card module 23; after receiving the notification of hardware verification failure sent by the mobile terminal main chip 22, not compare the customization information with that in the SIM card module 23, and prevent the communication between the mobile terminal main chip 22 and the SIM card module 23.

With the above solution, flexible network locking of the mobile terminal can be achieved, and in the case that the customization information is the operator information or the operator information and the partner information, in any network where the same operator or the same operator and partner can provide services, the mobile terminal can work normally by simply inserting the operator's customized SIM card, thus avoiding the problem that the mobile terminal must be returned and get network re-locked at the manufacturer when it is scheduled across networks inside the operator, and improving efficiency and reducing the cost. Meanwhile, the way of combining software and hardware is used to compare the information with each other; hence effectively preventing various illegal cracks to the mobile terminal software.

The above description is only the preferred embodiments of the present document and is not intended to limit the protection scope of the present document.

1. A network locking method for a mobile terminal, wherein, said mobile terminal has a built-in encryption chip, comprising:
storing customization information in a subscriber identity module (SIM) card, an encryption chip and a mobile terminal main chip respectively;
after said mobile terminal is powered on, said encryption chip comparing customization information stored therein with those in said mobile terminal main chip and said SIM card respectively, and after any comparison indicates that the information is inconsistent, preventing communication between said mobile terminal main chip and said SIM card.

2. The method of claim 1, wherein, said customization information is operator information, or operator information and partner information.

3. The method of claim 2, wherein, said storing customization information in the SIM card is: when said customization information is the operator information, writing the operator information into a group identification document 1 of said SIM card;
when said customization information is the operator information and the partner information, writing the operator information into the group identification document 1 of said SIM card, and writing the partner information into a group identification document 2 of said SIM card.

4. The method of claim 2, wherein, said encryption chip comparing customization information stored therein with that in said mobile terminal main chip is:
said encryption chip sending a information acquisition signal to said mobile terminal main chip and requesting to acquire the customization information;
after receiving the information acquisition signal, said mobile terminal main chip sending the customization information in a software security zone of itself to the encryption chip;
said encryption chip comparing the customization information stored therein with the customization information from said mobile terminal main chip, and when the information is inconsistent, preventing the communication between said mobile terminal main chip and said SIM card.

5. The method of claim 4, wherein, said method further comprises: said encryption chip comparing the customization information stored therein with the customization information from said mobile terminal main chip, and when the information is consistent, sending a software verification success signal to said mobile terminal main chip;
after receiving the software verification success signal, said mobile terminal main chip sending a information acquisition signal to said encryption chip, and requesting to acquire the customization information in said encryption chip;
after receiving the information acquisition signal from said mobile terminal main chip, said encryption chip sending the stored customization information to said mobile terminal main chip;
said mobile terminal main chip comparing the customization information in a software security zone of itself with the customization information from said encryption chip, and when the information is consistent, said mobile terminal main chip notifying said encryption chip that a hardware verification is successful, and after receiving the notification of the hardware verification success, said encryption chip executing the step of said encryption chip comparing customization information stored therein with that in said SIM card; when the information is inconsistent, notifying said encryption chip that the hardware verification is failed, and after said encryption chip receives the notification of the hardware verification failure, preventing the communication between said mobile terminal main chip and said SIM card.

6. The method of claim 1, wherein, said encryption chip comparing customization information stored therein with that in said SIM card is:
when there is a SIM card inserted in said mobile terminal, said encryption chip sending an information acquisition signal to said SIM card, and requesting to acquire the customization information in said SIM card;
after receiving said information acquisition signal, said SIM card sending the customization information stored therein to said encryption chip;
said encryption chip comparing the customization information stored therein with the customization information from said SIM card, and if the information is inconsistent, preventing the communication between said mobile terminal main chip and said SIM card.

7. The method of claim 6, wherein, said preventing the communication between said mobile terminal main chip and said SIM card is: the encryption chip of the mobile terminal intercepting communication information between said mobile terminal main chip and said SIM card, and interrupting normal communication between said mobile terminal main chip and said SIM card.

8. A mobile terminal, comprising: an encryption chip, a mobile terminal main chip, and a SIM card module; wherein
said encryption chip, in which customization information is stored, is used to, after said mobile terminal is powered on, compare the customization information stored in the encryption chip with the customization information of the mobile terminal main chip and the SIM card module respectively, and if any comparison indicates that the information is inconsistent, prevent communication between said mobile terminal main chip and said SIM card module;
said mobile terminal main chip, in which customization information is stored, is used to provide the customization information of the mobile terminal main chip itself to said encryption chip for comparison;
said SIM card module is used to read customization information in said SIM card, and provide that customization information to said encryption chip.

9. The mobile terminal of claim 8, wherein, said customization information is operator information or operator information and partner information.

10. The mobile terminal of claim 9, wherein, said encryption chip is specifically used to, after any comparison indicates that the information is inconsistent, intercept communication information between said mobile terminal main chip and said SIM card module, and interrupt normal communication between said mobile terminal main chip and said SIM card module.

11. The method of claim 2, wherein, said encryption chip comparing customization information stored therein with that in said SIM card is:
when there is a SIM card inserted in said mobile terminal, said encryption chip sending an information acquisition signal to said SIM card, and requesting to acquire the customization information in said SIM card;
after receiving said information acquisition signal, said SIM card sending the customization information stored therein to said encryption chip;
said encryption chip comparing the customization information stored therein with the customization information from said SIM card, and if the information is inconsistent, preventing the communication between said mobile terminal main chip and said SIM card.

12. The method of claim 3, wherein, said encryption chip comparing customization information stored therein with that in said SIM card is:
when there is a SIM card inserted in said mobile terminal, said encryption chip sending an information acquisition signal to said SIM card, and requesting to acquire the customization information in said SIM card;
after receiving said information acquisition signal, said SIM card sending the customization information stored therein to said encryption chip;
said encryption chip comparing the customization information stored therein with the customization information from said SIM card, and if the information is inconsistent, preventing the communication between said mobile terminal main chip and said SIM card.

13. The method of claim 4, wherein, said encryption chip comparing customization information stored therein with that in said SIM card is:
when there is a SIM card inserted in said mobile terminal, said encryption chip sending an information acquisition signal to said SIM card, and requesting to acquire the customization information in said SIM card;
after receiving said information acquisition signal, said SIM card sending the customization information stored therein to said encryption chip;
said encryption chip comparing the customization information stored therein with the customization information from said SIM card, and if the information is inconsistent, preventing the communication between said mobile terminal main chip and said SIM card.

14. The method of claim 5, wherein, said encryption chip comparing customization information stored therein with that in said SIM card is:
when there is a SIM card inserted in said mobile terminal, said encryption chip sending an information acquisition signal to said SIM card, and requesting to acquire the customization information in said SIM card;
after receiving said information acquisition signal, said SIM card sending the customization information stored therein to said encryption chip;
said encryption chip comparing the customization information stored therein with the customization information from said SIM card, and if the information is inconsistent, preventing the communication between said mobile terminal main chip and said SIM card.
